(19) United States
(12) Patent Application Publication
(10) Pub. No.: US 2005/0080499 A1
(43) Pub. Date: Apr. 14, 2005

(54) DIGITAL AUDIO SYSTEM HAVING A SHIFT CONTROLLER

(76) Inventor: Yu-Min Chang, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,044

(22) Filed: Feb. 4, 2004

(30) Foreign Application Priority Data
Oct. 13, 2003 (TW) 092128341

(51) Int. Cl. G06F 17/00

(52) U.S. Cl. 700/94

(57) ABSTRACT

A digital audio system has a register for storing data bits of digital audio signals, a multiplexer having a plurality of input ends connected to the register for selecting outputting data bits of the digital audio signals stored in the register, a shift controller connected to a selection end of the multiplexer for outputting corresponding bits according to the right-shifted number of bits of the data bits, and a digital to analog converter connected to an output end of the multiplexer for converting the digital audio signals into analog audio signals.

### BACKGROUND OF INVENTION

1. Field of the Invention

The present invention relates to a digital audio system and method thereof, and more particularly, to a digital audio system having a shift controller and a method for adjusting fade in and fade out effects of digital audio signals.

2. Description of the Prior Art

Normally, a digital audio system samples audio input signals in a predetermined period and quantifies the samplings. These quantified signals are then modulated by a modulation procedure, such as a pulse code modulation (PCM) procedure, to digital signals, such as PCM signals, which are composed of “0” and “1”. These PCM signals are used to transmit, record, or repeat the audio input signals.

In addition, the digital audio system is able to execute some edit functions, such as copy, paste, and delete, with its processor. Or even some special effects, for example, inverse waveforms, add echoes, fade in, or fade out can also be executed by the digital audio system. Fade in means that the volume is increased gradually to a preset volume when starting to play the audio signals, while fade out means the volume is diminished gradually from a preset volume to a mute condition when stopping playing the audio signals. Due to inherent limitation of speakers, however, it is easy for digital audio system to generate popping sounds when the volume changes dramatically, especially when starting to play or stopping playing the audio signals. To avoid these popping sounds, most digital audio systems use a fade in effect when starting to play the audio signals and use fade out effect when stopping playing the audio signals.

Presently, the conventional digital audio system multiplies the PCM signals by a predetermined weighted window with its processor for performing fade in and fade out effects. The multiplication operation of the PCM signals takes a portion of resources and thereby influences the efficiency. It may be a small effect for a computer host with powerful operation abilities. However, for a portable electronic device, the system will be more stable if less resources are used.

### SUMMARY OF INVENTION

It is therefore a primary objective of the present invention to provide a digital audio system having a shift controller and method thereof for adjusting fade in and fade out effects of digital audio signals to solve the above problems.

According to the claimed invention, a digital audio system and a method of adjusting digital audio signals are disclosed. The digital audio system comprises a register, a multiplexer, a shift controller, and a digital to analog converter. The register is for storing data bits of the digital audio signals. The multiplexer has an input end, a selection end, and an output end. The input end is connected to the register for selecting to output the data bits of the digital audio signals stored in the register. The shift controller is connected to the selection end of the multiplexer for controlling the multiplexer to output corresponding bits in accordance with a number of bits of the data bits to be right-shifted. The digital to analog converter is connected to the output end of the multiplexer for converting the digital audio signals outputted by the multiplexer into analog audio signals. The method of adjusting digital audio signals comprises altering data bits of the digital audio signals by right-shifting the data bits of the digital audio signals.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a function block diagram of a digital audio system according to the present invention.

FIG. 2 is a schematic diagram illustrating a method of executing a fade out effect according to the present invention.

FIG. 3 is a schematic diagram illustrating a method of executing a fade in effect according to the present invention.

FIG. 4 is a schematic diagram illustrating a method of executing a fade out effect in two steps according to the present invention.

### DETAILED DESCRIPTION

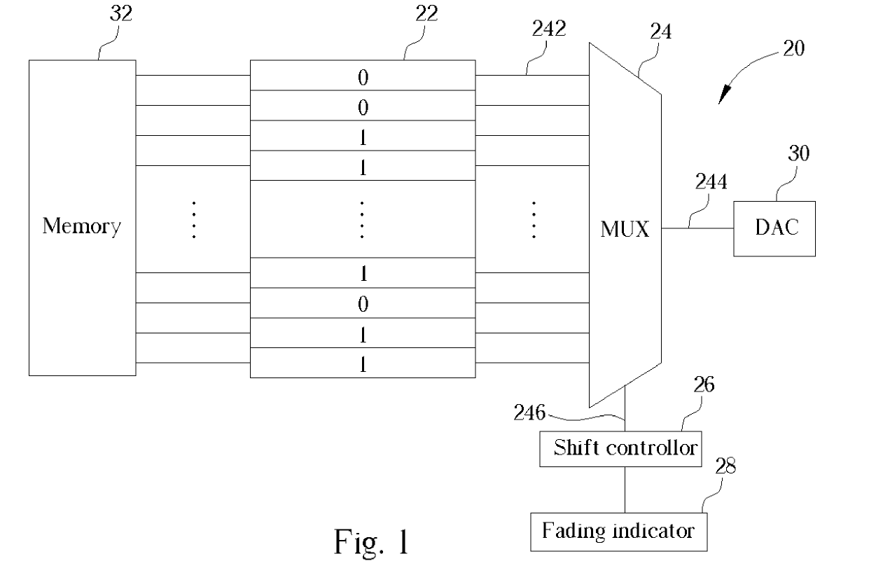

Please refer to FIG. 1. FIG. 1 is a function block diagram of a digital audio system 20 according to the present invention. The digital audio system 20 comprises a register 22, a multiplexer 24, a shift controller 26, a fading indicator 28, and a digital to analog converter (DAC) 30. The register 22 is for storing data bits of digital audio signals. The digital audio signals are delivered from a memory 32 to the register 22, and stored in the register 22 consecutively from a most significant bits (MSB) to least significant bits (LSB). The multiplexer 24 includes a plurality of input ends 242, an output end 244, and a selection end 246. Each input end 242 is respectively connected to each data bit stored in the register 22. The selection end 246 is for selecting to output the data bits of the digital audio signals stored in the register 22. The shift controller 26 is connected to the selection end 246 of the multiplexer 24 so as to control the multiplexer 24 to output corresponding bits in accordance with a number of the data bits to be right-shifted. The fading indicator 28 is connected to the shift controller 26 for outputting the number of bits, which is to be right-shifted, to the shift controller 26. The digital to analog converter 30 is connected to the output end 244 of the multiplexer 24 for converting the digital audio signals, outputted by the multiplexer 24, into analog audio signals. In normal conditions, the shift controller 26 is turned off, and thus the register 22 merely serves as a buffer of data bits. The data bits are outputted to the digital to analog converter 30 consecutively via the multiplexer 24 without being altered. When the fading indicator 28 emits an indicative signal, the shift controller 26 is turned on and begins to select the data bits to output to the digital to analog converter 30. For example, if the number of bits which is supposed to be right-shifted is 1 bit, the shift controller 26 will send a “0” to the digital to analog converter 30, and then consecutively deliver the data bits to the digital to converter 30 from the second bit of the register 22.

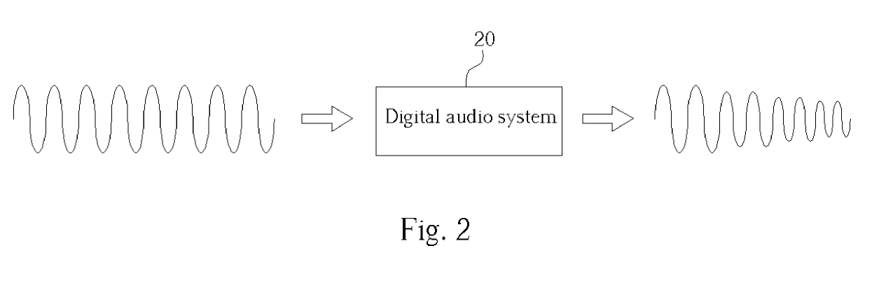

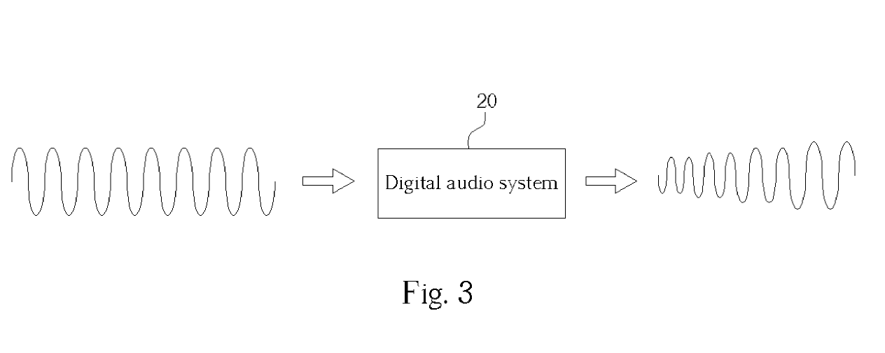

Please refer to FIG. 2 and FIG. 3. FIG. 2 is a schematic diagram illustrating a method of executing a fade out effect according to the present invention; FIG. 3 is a schematic diagram illustrating a method of executing a fade in effect according to the present invention. It is to be noted that if a string of binary data is right-shifted by 1 bit, equivalently, the string of binary data is divided by 2. Similarly, to right-shift the string of binary data 2 bits or 3 bits is equivalent to divide the string of binary data by 4 or 8 respectively. Therefore, this characteristic is employed to perform fade in and fade out effects in the present invention. As shown in FIG. 2, the PCM signals are delivered to the digital audio system 20 for performing the fade out effect. In this embodiment, set two wavelengths as a unit. First, right-shift the PCM signals by 1 bit. Then, right-shift the next two wavelengths of the PCM signals by 2 bits. Finally, right-shift the following next two wavelengths of the PCM signals by 3 bits. Accordingly, the PCM signals will diminish eventually. The fade in effect can be carried out in the opposite manner. First, right-shift the PCM signals by 3 bits. Then, right-shift the next two wavelengths of the PCM signals by 2 bits. Finally, right-shift the following next two wavelengths of the PCM signals by 1 bit. Accordingly, the PCM signals will regain to the original amplitude as shown in FIG. 3.

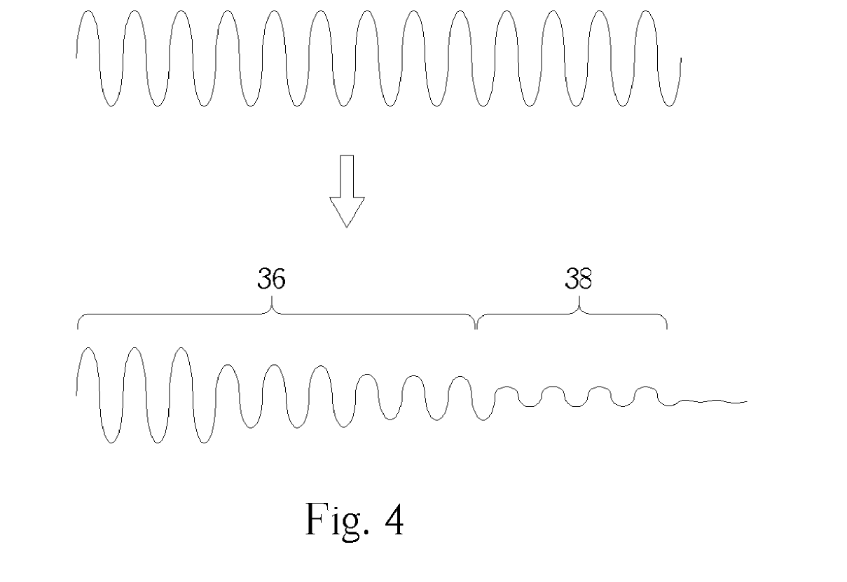

Please refer to FIG. 4. FIG. 4 is a schematic diagram illustrating a method of executing fade out effect in two steps. It is to be noted that the data bits of the PCM signals have difference weight. Substantially, the data bits close to the most significant bits (MSB) are more significant, and therefore the present invention adjusts the duration of fade in and fade out effects according to the length of each section of data bits. As shown in FIG. 4, the PCM signals are divided into a first section 36 and a second section 38. The first section 36 is more significant, and thus the data bits therein are right-shifted consecutively by 1, 2, and 3 bits every three wavelengths. The second section 38 is less significant, and thus the data bits therein are right-shifted consecutively by 1, 2, and 3 bits every one wavelength. A method of executing fade out and fade in effects is illustrated as follows. Assume that the length of PCM signals is 24 bits where the first section is 6 bits and the second section is 18 bits. The data bits in the first section are right-shifted, and the right-shifted number of bits increases by 1 bit every 300 units. The data bits of the second section are also right-shifted, but the right-shifted number of bits increases by 1 bit every 50 unit. Thus, the fade out effect is fulfilled. If the PCM signals are right-shifted by 24 bits, the PCM signals are in a mute condition. In this case, the first section is 18 bits and the second section is 6 bits. The data bits in the first section are right-shifted, and the right-shifted number of bits decreases by 1 bit every 50 units. The data bits in the second section are right-shifted, and the right-shifted number of bits decreases by 1 bit every 300 units. Consequently, the fade in effect is fulfilled. In addition, the duration of fade in and fade out effects equals [(6*300)+(18*50)]*(unit of time).

It can be seen that the present invention provides a digital audio system having a shift controller and method thereof for executing fade in and fade out effects with the digital audio system. The digital audio system uses the register, the multiplexer, and the shift controller for shifting the PCM signals so as to fulfill fade in and fade out effects. In addition, the duration of fade in and fade out is adjustable in accordance with the significance of the data bits. When the fade out effect is required, the number of bits of the data bits is right-shifted, and a number of bits of the data bits of the PCM signals outputted posteriorly is equal to or greater than a number of bits of the data bits outputted anteriorly. On the other hand, when the fade in effect is required, the number of bits of the data bits is also right-shifted, but a number of bits of the data bits of the PCM signals outputted anteriorly is equal to or greater than a number of bits of the data bits outputted posteriorly.

In comparison with the prior art, the present invention executes fade in and fade out effects by shifting the PCM signals. In addition, if the register, the multiplexer, and the shift controller are implemented by integrated circuits, processing resources can be spared by delivering the data bits several clocks later in accordance with the right-shifted number of bits.

Those skilled in the art will readily appreciate that numerous modifications and alterations of the device may be made without departing from the scope of the present invention. Accordingly, the above disclosure should be construed as limited only by the metes and bounds of the appended claims.

1. A method of adjusting digital audio signals, which comprises:
altering data bits of the digital audio signals by right-shifting the data bits of the digital audio signals.

2. The method of claim 1 wherein when the digital audio signals are fading out, a number of bits of the data bits is right-shifted, and a number of bits of the data bits of the digital audio signals outputted posteriorly is equal to or greater than a number of bits of the data bits outputted anteriorly.

3. The method of claim 1 wherein when the digital audio signals are fading in, a number of bits of the data bits is right-shifted, and a number of bits of the data bits of the digital audio signals outputted anteriorly is equal to or greater than a number of bits of the data bits outputted posteriorly.

4. The method of claim 1 wherein the digital audio signals are pulse-code modulation (PCM) signals.

5. A digital audio system capable of fading in and fading out digital audio signals, the digital audio system comprising:
a register for storing data bits of the digital audio signals;
a multiplexer having a plurality of input ends, a selection end, and an output end, the input end being connected to the register for selecting to output the data bits of the digital audio signals stored in the register;
a shift controller, connected to the selection end of the multiplexer, for controlling the multiplexer to output corresponding bits in accordance with a number of bits of the data bits to be right-shifted; and
a digital to analog converter, connected to the output end of the multiplexer, for converting the digital audio signals outputted by the multiplexer into analog audio signals.

6. The digital audio system of claim 5 wherein the digital audio system further comprises a fading indicator connected to the shift controller for outputting the number of bits of the data bits to be right-shifted to the shift controller.

7. The digital audio system of claim 5 wherein the digital audio signals are pulse-code modulation (PCM) signals.
